(19) United States
(12) Patent Application Publication
(10) Pub. No.: US 2009/0289382 A1
(43) Pub. Date: Nov. 26, 2009

(54) System and method for modifying characteristics of a contact lens utilizing an ultra-short pulsed laser

(75) Inventors: Donald P. Lijana, Oviedo, FL (US); Gregory J.R. Spooner, San Francisco, CA (US)

Correspondence Address: CARR & FERRELL LLP, 2200 GENG ROAD, PALO ALTO, CA, 94303, US

(73) Assignee: Raydiance, Inc.

(21) Appl. No.: 12/154,642

(22) Filed: May 22, 2008

(51) Int. Cl. B29D 11/00

(52) U.S. Cl. 264/1.37; 425/174

(57) ABSTRACT

A system and method for modifying a characteristic of a contact lens is presented. A beam of ultra-short pulses is generated. The beam of ultra-short pulses is delivered to a desired location at the contact lens. A characteristic of the contact lens is modified at the desired location using the beam of ultra-short pulses.

### BACKGROUND OF THE INVENTION

1. Technical Field

The present invention relates generally to the field of ultra-short pulsed lasers and, particularly to modifying characteristics of a contact lens using an ultra-short pulsed laser.

2. Description of Related Art

Fields of technological advancements in contact lenses include comfort and ability to correct vision of a wearer. One major factor in the comfort to the wearer is referred to as permeability. Permeability is a measure of an ability for oxygen to pass through the contact lens to reach a cornea of the wearer. Conventionally, permeability has been increased through advances in materials. Until the late 1970s, contact lenses were generally made from one of two materials. Hard contact lenses were made of polymethylmethacrylate (PMMA), while soft contact lenses were made of hydroxyethylmethacrylate (HEMA). HEMA is a hydrated polymer and contains about 38% water by weight. The contact lenses made of PMMA or HEMA provided clear vision and comfort with one critical problem. The critical problem being that these contact lenses hindered oxygen from reaching the corneas of contact lens wearers. In an absence of oxygen, the cornea can change adversely resulting in ocular irritation, fatigue, and general discomfort in some of the contact lens wearers.

PMMA is now obsolete as a hard contact lens material and has been replaced by rigid plastics, most of which are hydrophobic materials with higher oxygen permeability relative to PMMA. The contact lenses made of these rigid plastics are known as rigid gas permeable (RGP) contact lenses. For the manufacture of soft contact lenses, HEMA is being replaced by polymers referred to as hydrogels that may contain about 80% water. The soft contact lenses made of hydrogels have higher oxygen permeability relative to HEMA. The introduction of new contact lens materials (e.g., RGP plastics and hydrogels) has lead to the manufacture of thinner contact lenses. The thinner contact lenses make wearing contact lenses more comfortable, while reducing the cost to manufacture. However, permeability remains a key issue with contact lenses.

To correct the vision of the wearer, the contact lens refracts light that enters the eye of the wearer. The shape and material of the contact lens affect how the light is refracted. Conventionally, manufacturing both hard and soft contact lenses involves molding or stamping the contact lenses. Typically, the contact lenses are form fitted to diopter increments of 0.25. A diopter is a unit of measurement of refractive power of a lens. Furthermore, unique prescriptions for contact lenses are generally unavailable. The unique prescriptions may be prescriptions between 0.25 diopter increments or prescriptions for severe vision conditions. The severe vision conditions may include extreme farsightedness (hyperopia), extreme nearsightedness (myopia), astigmatism, or farsightedness due to ciliary muscle weakness and loss of elasticity in the crystalline lens (presbyopia). The dies required to form the contact lenses are expensive to produce and require periodic maintenance and replacement making them cost prohibitive for the unique prescriptions.

### SUMMARY OF THE INVENTION

Embodiments of the present invention provide systems and methods for modifying a characteristic of a contact lens. According to various embodiments, the characteristic may at least include permeability of the contact lens and corrective properties of the contact lens. In exemplary embodiments, a system may utilize an ultra-short pulsed laser to generate a beam of ultra-short pulses. The beam may be delivered to a desired location at the contact lens. In some embodiments, the beam may be coupled to an optical fiber and/or be directed by use of conventional optical elements.

Upon delivery of the beam to the desired location, the characteristic of the contact lens may be modified. In one example, the characteristic may be modified at a surface of the contact lens by ablating a material from which the contact lens is made. Alternatively or additionally, the characteristic may be modified within the contact lens by damaging the material at the desired location. The beam may move relative to the contact lens such that, for example, features are created in the contact lens.

### BRIEF DESCRIPTION OF THE DRAWINGS

FIG. 1 illustrates an exemplary system to modify the characteristics of a contact lens.

FIG. 2 illustrates an exemplary assembly of a contact lens and a cornea.

FIG. 3 illustrates, in cross-section, an exemplary ablation process at a surface of a contact lens.

FIG. 4 illustrates, in cross-section, an exemplary damaging process at a contact lens.

FIG. 5 illustrates a contact lens having exemplary distributions of features created by the system.

FIG. 6 illustrates, in cross-section, an exemplary contact lens modified by the system.

FIG. 7 illustrates, in cross-section, an alternative contact lens modified by the system.

FIG. 8 illustrates, in cross-section, another embodiment of a contact lens modified by the system.

FIG. 9 illustrates, in cross-section, another exemplary contact lens modified by the system.

### DETAILED DESCRIPTION OF THE INVENTION

An ultra-short pulsed laser may provide a capability to modify characteristics of a contact lens. The characteristics may at least include permeability of the contact lens and corrective properties of the contact lens. The permeability may relate to gas permeability or liquid permeability. The corrective properties may relate to the way in which light is refracted by the contact lens to correct vision conditions. The ultra-short pulsed laser may be fabricated using techniques of laser fabrication known in the art.

The ultra-short pulsed laser emits optical pulses having temporal lengths in a range of picoseconds to femtoseconds resulting in a very high electric field for a short duration of time. The emitted optical pulses may be referred to as ultra-short pulses. The ultra-short pulses may modify the characteristics of a material from which the contact lens is made. The ultra-short pulses may ablate, damage, or not affect the material.

Ablating the material (also referred to as ablation) from which the contact lens is made may occur when a level of energy delivered to the material by the ultra-short pulses exceeds an ablation threshold of the material. Ablation may result in material removal by sublimation. In contrast to conventional laser machining, which uses continuous-wave lasers or long-pulsed lasers (e.g., lasers that emit optical pulses with temporal lengths greater than roughly 1 nanosecond), ablation using the ultra-short pulsed laser may generally be athermal. As such, virtually no heat may be transferred to the material during ablation.

Damaging the material from which the contact lens is made may occur when the level of energy delivered to the material by the ultra-short pulses exceeds a damage threshold of the material and is less than the ablation threshold. Damaging the material may include altering an intensive physical property (also referred to as a bulk property) of the material such as a mechanical property of the material or an optical property of the material. The mechanical property may be, for example, porosity, density, hardness, Young's modulus, or strain. The optical property may be, for example, absorptivity, reflectivity, index of refraction, or transmittance. Damaging the material using the ultra-short pulsed laser may also generally be athermal. As those skilled in the art will recognize, the ultra-short pulsed laser may modify the index of refraction or other optical properties without causing ablation or other gross damage. For example, waveguide writing using ultra-short pulsed lasers may be utilized to modify the index of refraction or other optical properties.

The material may not be affected (i.e., no material removed and no intensive physical property altered) when the level of energy delivered to the material by the ultra-short pulses does not exceed the ablation threshold or the damage threshold. The level of energy delivered may depend on the proximity to a focal point when the ultra-short pulses are focused by, for example, a lens. In one example, the level of energy at the focal point may exceed the ablation threshold resulting in ablation at the focal point, while the level of energy away from the focal point may not exceed the ablation or damage threshold. The focal point may be positioned at a surface of the material or within the material. Furthermore, the wavelength and/or output power at which the ultra-short pulsed laser operates may be tuned to provide increased control of the ultra-short pulses in ablating, damaging, or not affecting the material.

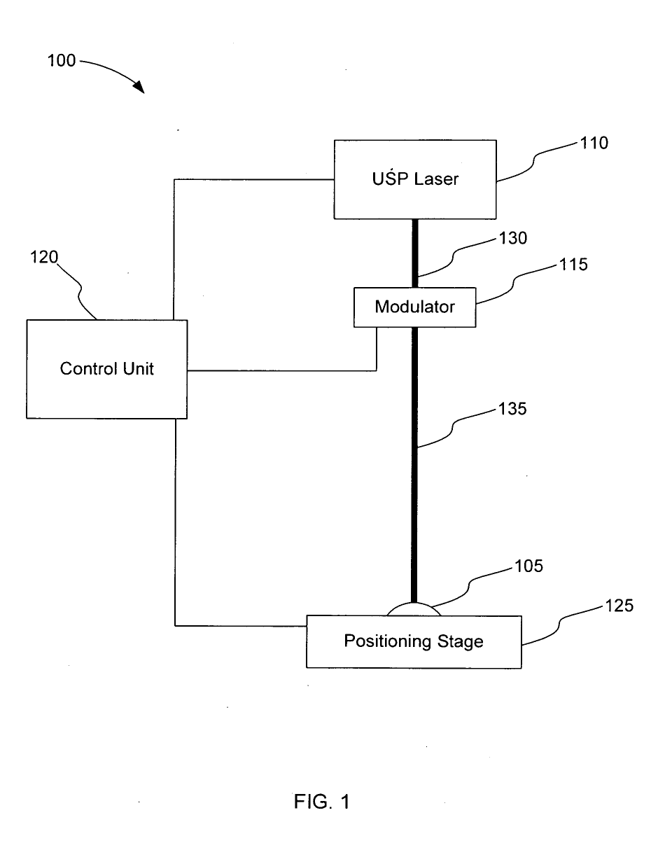

FIG. 1 illustrates an exemplary system 100 to modify the characteristics of a contact lens 105. The system 100 may comprise an ultra-short pulsed laser 110, a beam modulator 115, and a control unit 120. As will be apparent to those skilled in the art, the system 100 may further include a positioning stage 125.

The ultra-short pulsed laser 110 emits a beam 130 of ultra-short pulses. In some embodiments, the beam 130 may be coupled to an optical fiber or other waveguide. One exemplary embodiment of the system 100 comprises a Bragg optical fiber, as described in U.S. Pat. No. 7,349,452, filed Apr. 22, 2005, and entitled “Bragg Fibers in Systems for Generation of High Peak Power Light,” which is hereby incorporated by reference. In other embodiments, the beam 130 may propagate without a waveguide and be directed or routed by use of conventional optical elements, such as lenses and mirrors.

The beam modulator 115 may modulate the beam 130 providing control of whether the ultra-short pulses are allowed to propagate further in the system 100. In some embodiments, the beam modulator 115 may mechanically block or unblock the beam 130. A modulated beam 135 of ultra-short pulses may proceed from the beam modulator 115. Similarly with the beam 130, the modulated beam 135 may be coupled to an optical fiber or other waveguide according to some embodiments. Conversely, the modulated beam 135 may propagate without a waveguide and be directed or routed by use of conventional optical elements, such as lenses and mirrors, according to other embodiments. Subsequently, the modulated beam 135 may impinge on the contact lens 105. In alternative embodiments, the beam modulator 115 may be integrated with the ultra-short pulsed laser 110 as a single component of the system 100.

According to various embodiments, the contact lens 105 may be any type of contact lens, conventional or otherwise. Because the ultra-short pulsed laser 110 may be tuned to produce ultra-short pulses that may ablate, damage, and/or not affect virtually any material, the material from which the contact lens 105 is made may generally be inconsequential. In some embodiments, the contact lens 105 may have a number of preexisting characteristics (e.g., the permeability and the corrective properties of the contact lens 105). In one embodiment, the contact lens 105 may be a standard prescribed lens that is commercially available. In another embodiment, the contact lens 105 may be a blank lens that is substantially cylindrical and provides no corrective properties prior to modification by the system 100.

In exemplary embodiments, the contact lens 105 may be held or placed upon the positioning stage 125. The exemplary positioning stage 125 is configured to position the contact lens 105 such that the modulated beam 135 may impinge the contact lens 105 at a desired location. The desired location is a location at which ablation or damage to the material is desired. According to various embodiments, the positioning stage 125 may operate by linear translation in one, two, or three dimensions and/or by rotation. The positioning stage 125 may be designed to accommodate a variety of different shapes and sizes of contact lenses. The positioning stage 125 may also be configured to simultaneously hold a plurality of contact lenses, in accordance with some embodiments. In other embodiments, multiple positioning stages 125 may be included in the system 100.

In one alternative embodiment, a beam steerer may replace or augment the positioning stage 125. The beam steerer may control the position of the modulated beam 135 relative to the contact lens 105 such that the modulated beam 135 may impinge the contact lens 105 at the desired location. In another alternative embodiment, an optical fiber to which the modulated beam 135 of ultra-short pulses is coupled to may be moved relative to the contact lens 105. The modulated beam 135 emanating from an end of the optical fiber may subsequently be positioned proximate to the desired location. In yet another embodiment, a beam scanning system may substitute or augment the positioning stage 125.

The exemplary control unit 120 may be configured to coordinate and/or control the operation of at least the ultra-short pulsed laser 110, the beam modulator 115, and/or the positioning stage 125. In one example, the control unit 120 may determine the wavelength and/or output power at which the ultra-short pulsed laser 110 operates. Furthermore, the control unit 120 may coordinate the operation of the beam modulator 115 with the operation of the positioning stage 125 such that the modulated beam 135 impinges the contact lens 105 only at the desired location. According to various embodiments, the control unit 120 may be a physical instrument or a virtual instrument (e.g., a LabVIEW virtual instrument).

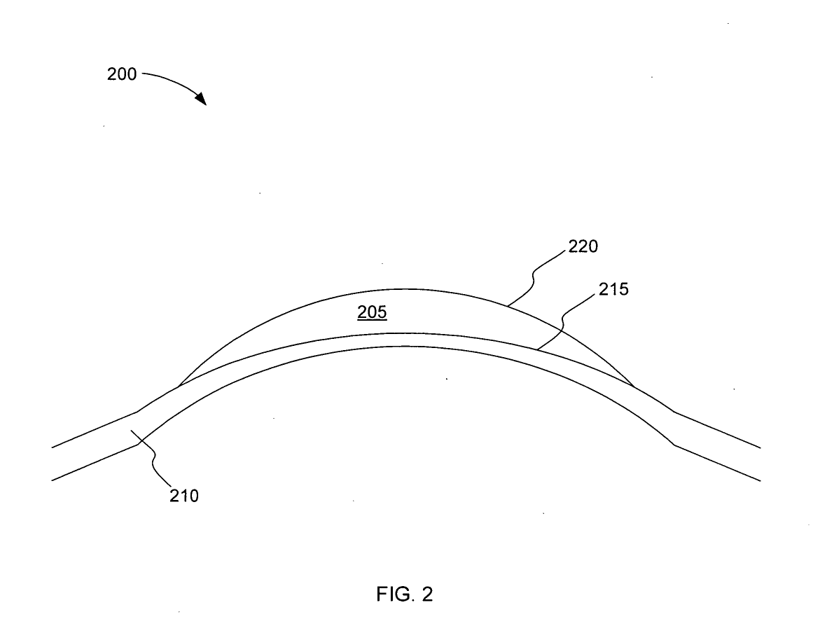

FIG. 2 illustrates an exemplary assembly 200 of a contact lens 205 and a cornea 210. According to various embodiments, the contact lens 205 may abut the cornea 210 to correct vision conditions. An inner surface 215 of the contact lens 205 is adjacent to the cornea 210. The contact lens 205 may be designed such that the inner surface 215 may be compatible with a curvature of the cornea 210. Furthermore, an adequate level of oxygen for acceptable corneal health may pass through the contact lens 205 from an outer surface 220 to the inner surface 215 to reach the cornea 210.

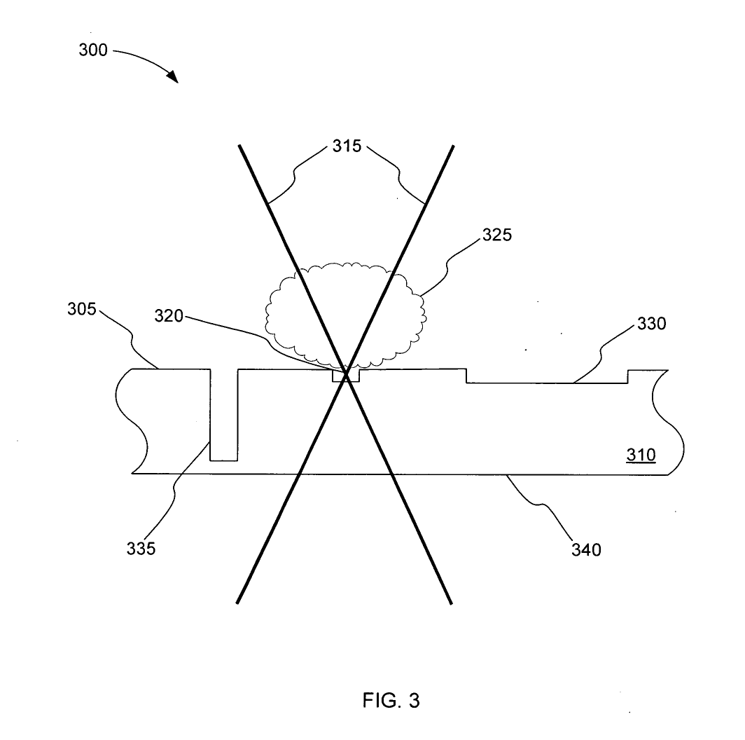

FIG. 3 illustrates, in cross-section, an exemplary ablation process 300 at a surface 305 of a contact lens 310. Boundaries 315 define a focal point 320 of the modulated beam 135 of ultra-short pulses. The level of energy delivered by the modulated beam 135 exceeds the ablation threshold at the focal point 320 resulting in the material at the focal point 320 to be ablated. It may be noted that the level of energy delivered by the modulated beam 135 away from the focal point 320 is low enough such that the material away from the focal point 320 is not affected.

In some examples, as the material at the focal point 320 is ablated, ablation ejecta may form a cloud 325 of vaporized material. The cloud 325 may partially block the modulated beam 135 from impinging on the desired location, which may decrease a rate of material removal. In some embodiments, the cloud 325 may be removed from the vicinity of the focal point 320 by compressed gas or liquid, or be blown away from the focal point 320 by a fan. In other embodiments, the focal point 320 may constantly be moved away from the cloud 325 by, for example, moving the contact lens 310 using the positioning stage 125.

According to various embodiments, a feature 330 at the surface 305 may be created by moving the focal point 320 along the surface 305. While the focal point 320 moves along the surface 305, the material at the focal point 320 is ablated leaving a void. In one example, the focal point 320 is moved relative to the contact lens 310 by moving the contact lens 310 using the positioning stage 125. In another example, the focal point 320 is moved relative to the contact lens 320 by moving the modulated beam 135 using the beam steerer. In yet another example, the system 100 may include both the positioning stage 125 and the beam steerer, such that both the modulated beam 135 and the contact lens 310 may be moved simultaneously. One skilled in the art would recognize that the feature 330 may be any shape or size at the surface 305 and that there may be multiple features 330 in the contact lens 310.

In various embodiments, a feature 335 may be created by moving the focal point 320 perpendicular to the surface 305. Creating the feature 335 may be analogous to drilling a hole. In one example, the focal point 320 is moved relative to the contact lens 310 by moving the contact lens 310 using the positioning stage 125. One skilled in the art would recognize that the feature 335 may extend part of the way through the contact lens 310, as depicted in FIG. 3, or extend all of the way through the contact lens 310 joining the surface 305 to a surface 340. Furthermore, there may be multiple features 330 and 335 in the contact lens 310.

The presence of the features 330 and 335 may modify the characteristics of the contact lens 310. In alternative embodiments, processes of creating the features 330 and 335 may be combined. The combined processes may facilitate creating features with various dimensions parallel and perpendicular to the surface 305. Further, the combined processes may facilitate creating complex features, described further herein. Additionally, in some embodiments, voids (e.g., the features 330 and 335) may be filled with materials other that the material from which the contact lens 310 is made, which have desirable characteristics. In one example, the voids may be filled with a liquid (e.g., artificial tears) to match the index of refraction of the material from which the contact lens 310 is made while increasing permeability of the contact lens 310.

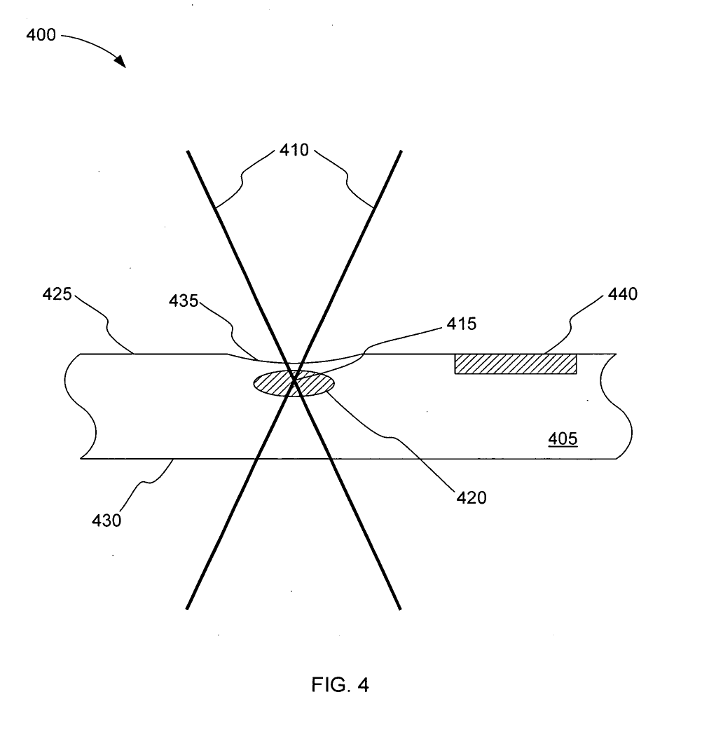

FIG. 4 illustrates, in cross-section, an exemplary damaging process 400 at a contact lens 405. Boundaries 410 define a focal point 415 of the modulated beam 135 of ultra-short pulses. The level of energy delivered by the modulated beam 135 exceeds the damage threshold and is less than the ablation threshold at the focal point 415 resulting in the material at the focal point 415 to be damaged. It may be noted that the level of energy delivered by the modulated beam 135 away from the focal point 415 is low enough such that the material away from the focal point 415 is not affected.

According to various embodiments, a feature 420 within the contact lens 405 may be created by positioning the focal point 415 between surfaces 425 and 430. In one example, the focal point 415 may be moved relative to the contact lens 405 by moving the contact lens 405 using the positioning stage 125. In another example, the focal point 415 may be moved relative to the contact lens 415 by moving the modulated beam 135 using the beam steerer. One skilled in the art would recognize that the feature 420 may be any shape or size and that there may be multiple features 420 at the contact lens 405.

The presence of the feature 420 may modify the characteristics of the contact lens 405 according to some embodiments. In the example depicted in FIG. 4, the density of the material at the feature 420 may be changed, thus resulting in a consequential feature 435 being created at the surface 425. The consequential feature 435 may alter a contour of the surface 425 without significantly increasing surface roughness. The surface roughness may cause ocular irritation and may be difficult to reduce.

In various embodiments, a feature 440 at the surface 425 may be created by moving the focal point 415 along the surface 425. While the focal point 415 moves along the surface 425, the material at the focal point 415 is damaged. In one example, the focal point 415 is moved relative to the contact lens 405 by moving the modulated beam 135 using the beam steerer. One skilled in the art will recognize that the feature 440 may be any shape or size at the surface 425 and that there may be multiple features 440 at the contact lens 405. Furthermore, the feature 440 may extend from the surface 425 to the surface 430. The presence of the feature 440 may modify the characteristics of the contact lens 405 according to some embodiments

In some embodiments, the material at the feature 440 may be left intact. In other embodiments, the material at the feature 440 may be removed. In one example, the material at the feature 440 may be removed by a chemical process. In another example, the material at the feature 440 may be removed by a plasma etch. When the material at the feature 440 is removed, a void may be left resembling the feature 330.

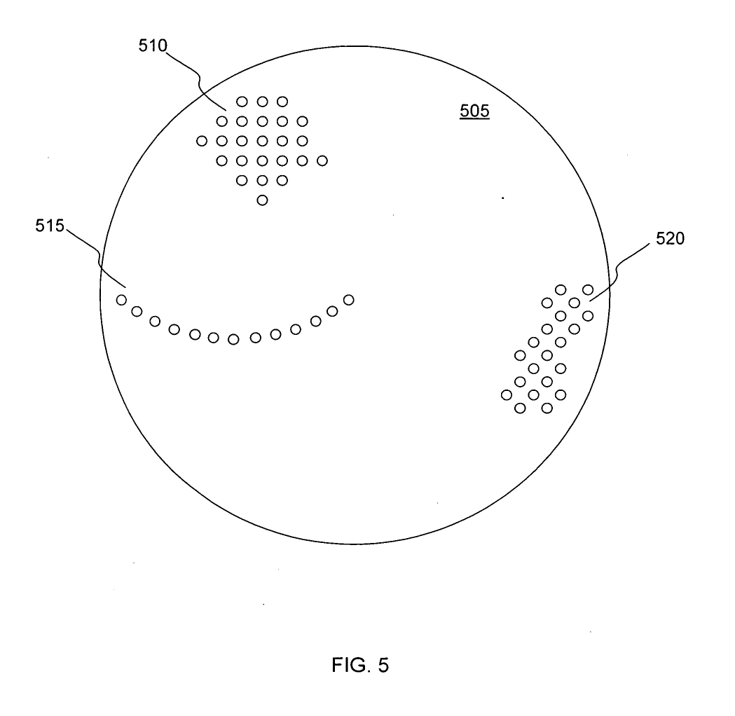

FIG. 5 illustrates a contact lens 505 having exemplary distributions 510-520 of features created by the system 100. The distributions 510-520 may each include one or more of the features 330, 335, 420, 440, and other features discussed herein. In some embodiments, the distributions 510-520 may be designed to modify the characteristics of the contact lens 505. In other embodiments, the distributions 510-520 may entirely cover or cover a portion of the contact lens 505. One skilled in the art would recognize that the distributions 510-520 may include any combination of feature sizes, shapes, patterns, compositions, and distribution densities.

FIG. 6 illustrates, in cross-section, an exemplary contact lens 605 modified by the system 100. The contact lens 605 includes blind-holes 610. A single blind-hole may be generally described as a cavity that is open to one surface of the contact lens 605, but closed to an opposite surface. According to various embodiments, the blind-holes 610 may be created by the ablation process 300 or the damaging process 400 using the system 100. The blind-holes 610 may be distributed in various ways in the contact lens 605, including the distributions described in connection with FIG. 5. In one embodiment, the blind-holes 610 may be arranged in an alternating fashion such that every other blind-hole 610 is open to a first surface 615 and the rest are open to a second surface 620. In an alternative embodiment, the blind-holes 610 may be arranged such that they are all open to the same surface (e.g., the first surface 615). In one embodiment, the blind-holes 610 may each be approximately cylindrical with the symmetry axis of the cylindrical shape parallel or misaligned to the surface normal.

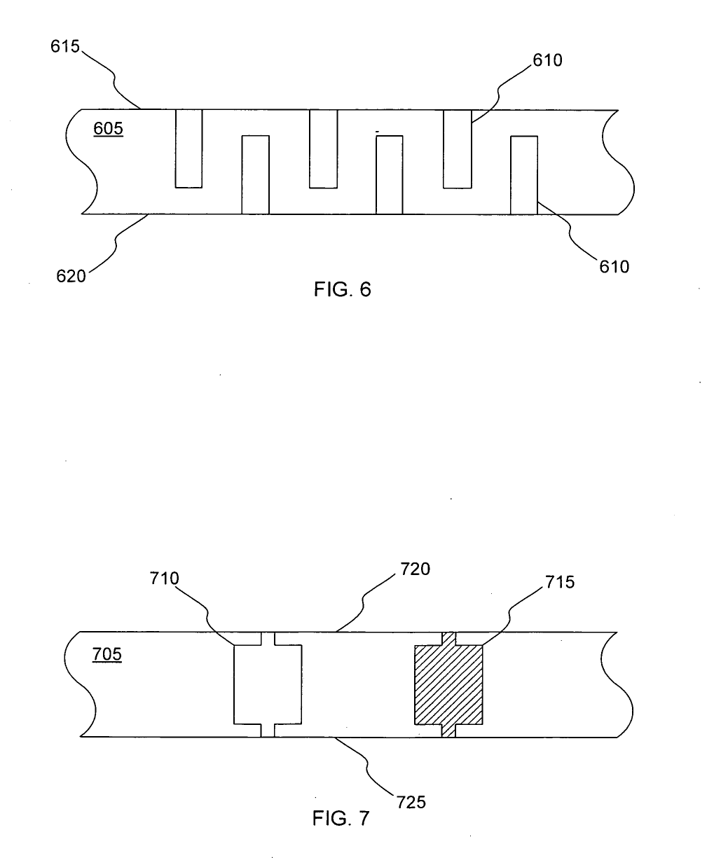

FIG. 7 illustrates, in cross-section, an exemplary contact lens 705 modified by the system 100. The contact lens 705 includes features 710 and 715 that join surfaces 720 and 725. In one embodiment, the feature 710 may be created by the ablation process 300 using the system 100. In another embodiment, the feature 710 may be created by the damaging process 400 using the system 100 and subsequently removing the material as discussed herein. The feature 715 may be created by damaging the material using the system 100, in accordance to various embodiments. One skilled in the art will recognize that the features 710 and 715 may have a variety of shapes. According to various embodiments, the contact lens 705 may include any number or combination of the features 710 and 715 in any distribution (e.g., the distributions described in connection with FIG. 5).

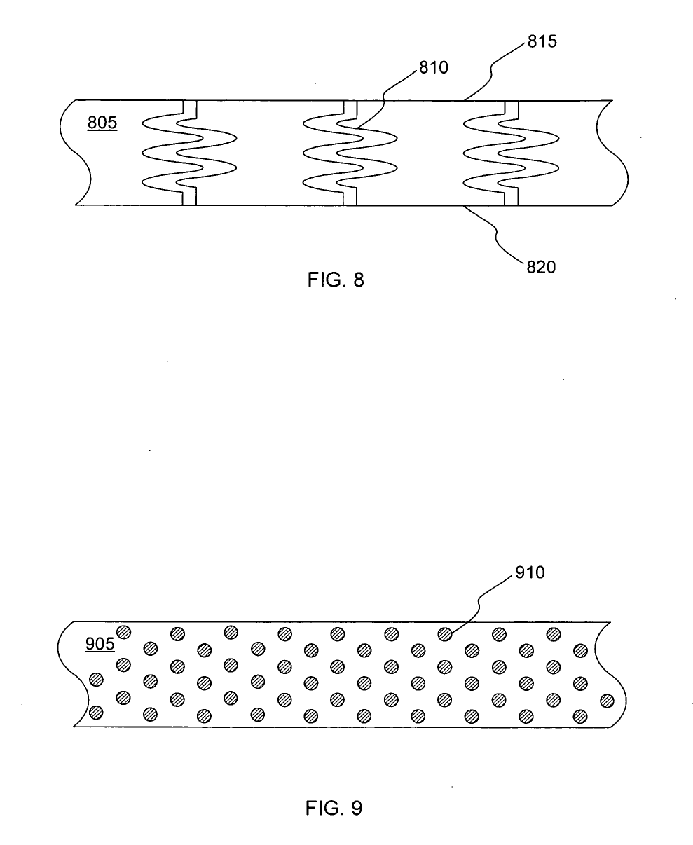

FIG. 8 illustrates, in cross-section, an exemplary contact lens 805 modified by the system 100. The contact lens 805 includes features 810 having a complex design. According to various embodiments, the features 810 may be created by the ablation process 300 or the damaging process 400 using the system 100. The material at the features 810 may be intact or removed as discussed in connection to FIG. 4. The features 810 may extend to both, one, or none of surfaces 815 and 820. One skilled in the art will recognize that the features 810 may have a variety of shapes. The contact lens 805 may include any number or combination of the features 810 in any distribution (e.g., the distributions described in connection with FIG. 5), in accordance with various embodiments.

FIG. 9 illustrates, in cross-section, an exemplary contact lens 905 modified by the system 100. The contact lens 905 includes an array 910 of substantially identical features. According to various embodiments, the array 910 may be created by the ablation process 300 or the damaging process 400 using the system 100. In the example depicted in FIG. 9, the array 910 is within the contact lens 905. In other embodiments, the array 910 may be on a surface of the contact lens 905. One skilled in the art will recognize that the array 910 may include regular or irregular patterns. Furthermore, the substantially identical features may, at least, include the features described herein, according to various embodiments.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. A method for modifying a characteristic of a contact lens comprising:
generating a beam of ultra-short pulses;
delivering the beam of ultra-short pulses to a desired location at the contact lens; and
modifying a characteristic of the contact lens at the desired location using the beam of ultra-short pulses.

2. The method of claim 1 wherein modifying the characteristic comprises ablating a portion of the contact lens at the desired location.

3. The method of claim 1 wherein modifying the characteristic comprises damaging a portion of the contact lens at the desired location to create a damaged portion.

4. The method of claim 3 further comprising removing the damaged portion of the contact lens.

5. The method of claim 3 wherein the damaged portion is at a surface of the contact lens.

6. The method of claim 3 wherein the damaged portion is internal to the contact lens.

7. The method of claim 3 wherein the damaged portion is joined to a surface of the contact lens by a hole.

8. The method of claim 3 further comprising modifying a curvature of the contact lens using the damaged portion.

9. The method of claim 1 further comprising moving the contact lens to a predetermined position relative to the beam of ultra-short pulses such that the beam of ultra-short pulses impinges the desired location.

10. The method of claim 1 further comprising creating a feature in the contact lens at the desired location.

11. The method of claim 10 wherein the feature is an essentially cylindrical perforation.

12. The method of claim 10 wherein the feature is a blind-hole.

13. The method of claim 10 wherein the feature comprises an array of essentially identical features.

14. The method of claim 10 wherein the feature is configured to increase permeability of the contact lens without direct connection to a surface of the contact lens.

15. A system for modifying a characteristic of a contact lens comprising:
an ultra-short pulsed laser configured to generate a beam of ultra-short pulses to modify a characteristic of a contact lens;
a beam modulator configured to modulate the beam of ultra-short pulses; and
a control unit configured to control the ultra-short pulsed laser and the beam modulator.

16. The system of claim 15 further comprising a positioning stage configured to position the contact lens relative to the beam of ultra-short pulses.

17. The system of claim 16 wherein the positioning stage is further configured to position in three spatial dimensions.

18. The system of claim 16 wherein the positioning stage is further configured to hold an array of contact lenses.

19. The system of claim 15 further comprising a beam steerer configured to steer the beam of ultra-short pulses.
